(19) United States
(12) Patent Application Publication
(10) Pub. No.: US 2006/0284915 A1
(43) Pub. Date: Dec. 21, 2006

(54) METHOD AND APPARATUS TO CONTROL A TEMPERATURE OF A PRINTER HEAD CHIP

(76) Inventor: Chun-ku HAN, Seoul (KR)

Correspondence Address: STANZIONE & KIM, LLP, 919 18TH STREET, N.W., SUITE 440, WASHINGTON, DC, 20006, US

(21) Appl. No.: 11/424,619

(22) Filed: Jun. 16, 2006

(30) Foreign Application Priority Data
Jun. 17, 2005 (KR) 2005-52535

(51) Int. Cl. B41J 29/38

(52) U.S. Cl. 347/17

(57) ABSTRACT

A method and an apparatus to control a temperature of a printer head chip. The temperature control apparatus includes a heater, a temperature sensor, and a controller. The heater heats a predetermine portion of the printer head chip. The temperature sensor senses the temperature of the printer head chip. The controller is provided in the printer head chip and provides a control signal to the heater according to the sensed temperature. Accordingly, damage to the printer head chip can be prevented and safety in using the printer can be guaranteed. Also, ink droplets can be accurately ejected from the printer head chip such that printing quality is improved and a life span of the heater is extended.

### CROSS-REFERENCE TO RELATED APPLICATIONS

This application claims the benefit of Korean Patent Application No. 2005-52535, filed on Jun. 17, 2005, in the Korean Intellectual Property Office, the disclosure of which is incorporated herein in its entirety by reference.

### BACKGROUND OF THE INVENTION

1. Field of the Invention

The present general inventive concept relates to an image-forming apparatus, and more particularly, to a method and an apparatus to control a temperature of a printer head chip provided in a thermal inkjet printer.

2. Description of the Related Art

Inkjet printers can be classified as a continuous injection type or a drop-on-demand (DOD) type according to an injection method thereof. The DOD type can be further classified as a type that uses a piezoelectric actuator or a thermal type that uses bubbles to eject ink. The thermal type creates bubbles on a surface of a thermal resistor using heat generated by a current that flows and is dissipated by the thermal resistor such that the ink is ejected through nozzles using an expansion force of a volume of the bubbles.

When a printing resolution and a printing speed are increased in a thermal inkjet printer, the printer head chip tends to overheat. Bubble creation within the printer head chip is directly affected by temperature, so that the overheating of the printer head chip hinders the creation of the bubbles, and ink droplets are ejected too early. The early ejection of the ink droplets causes a printing abnormality such as an undesired ink mark on a recording medium. Also, when the printer head chip overheats, unintended vapor bubbles are accumulated within the ink, which blocks the nozzles and hinders emission of the ink droplets. Also, the overheating of the printer head chip shortens a life span of a heater (e.g., the thermal resistor).

FIG. 1 is a block diagram illustrating a conventional temperature control apparatus used to control a temperature of a printer head chip 100. The conventional temperature control apparatus includes the printer head chip 100, a head controller 150, and a power supply 140.

The printer head chip 100 includes a heater 110, a heating controller 120, and a temperature sensor 130. The heater 110 heats up a predetermined portion in the printer head chip 100 to eject ink droplets. The heating controller 120 controls the heater 110, and the temperature sensor 130 senses the temperature of the printer head chip 100.

The power supply 140 supplies power required for heating the printer head chip 100 to the heater 110.

The head controller 150 controls the printer head chip 100 according to the temperature sensed by the temperature sensor 130.

Only the temperature sensor 130 is provided within the printer head chip 100 and the head controller 150 is provided outside of the printer head chip 100 to control the printer head chip 100 according to the temperature sensed by the temperature sensor 130. If the head controller 150 is provided outside of the printer head chip 100 for controlling the temperature of the printer head chip 100, the printer head chip 100 can be overheated and damaged, or a fire can result when the temperature within the printer head chip 100 abruptly rises or an error occurs in a main system of a printer having the head controller 150. Accordingly, a safety problem is generated in using the conventional temperature controlling apparatus with the printer.

### SUMMARY OF THE INVENTION

The present general inventive concept provides a method and an apparatus to control a temperature of a printer head chip in a thermal inkjet printer by providing a controller that stops a heating of the printer head chip within the printer head chip.

The present general inventive concept also provides a method and an apparatus to control a temperature of a printer head chip in a thermal inkjet printer by providing a power cut-off part to cut off power supplied for heating a printer head chip.

The present general inventive concept also provides a method and an apparatus to control a temperature of a printer head chip in a thermal inkjet printer by providing a power cut-off part to cut off power supplied to the printer head chip.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a temperature control apparatus to control a temperature of a printer head chip, the apparatus including a heater to heat a predetermined portion of the printer head chip, a temperature sensor provided on the printer head chip to sense the temperature of the printer head chip, and a controller provided on the printer head chip to control the heater according to the sensed temperature.

The controller may include a temperature comparator to compare the sensed temperature with a predetermined critical temperature and to output a result of the comparison and a control signal generator to output a control signal that stops the heater from heating the printer head chip according to the result of the comparison.

The apparatus may further include a surrounding-temperature sensor to sense a surrounding temperature of the printer head chip and to provide the sensed surrounding temperature to the controller such that the controller outputs a second control signal to the heater according to the sensed temperature sensor and the sensed surrounding temperature.

The temperature sensor may be one of a thermistor, a diode sensor, and a digital sensor.

The foregoing and/or other aspects of the present general inventive concept may also be achieved by providing a temperature control apparatus to control a temperature of a printer head chip, the apparatus including a heater to heat a predetermined portion of the printer head chip, a temperature sensor unit to sense an internal temperature of the printer head chip and a surrounding temperature of the printer head chip, and a controller provided on the printer head chip to cut off power supplied to the heater according to the sensed internal and surrounding temperatures.

The controller may include a temperature comparator to compare the sensed internal and surrounding temperatures with predetermined critical temperatures and to output a result of the comparison and a power cut-off part to cut off the power supplied to the heater in response to the compared result.

The temperature sensor unit may include an internal temperature sensor disposed inside the printer head chip to sense the internal temperature of the printer head chip, and a surrounding-temperature sensor disposed outside the printer head chip to sense the surrounding temperature of the printer head chip and to provide the sensed surrounding temperature to the controller such that the controller cuts off the power supplied to the heater according to the sensed internal temperature and the sensed surrounding temperature.

The foregoing and/or other aspects of the present general inventive concept may also be achieved by providing a temperature control apparatus of a printer head chip, the apparatus including a temperature sensor provided on the printer head chip to sense a temperature of the printer head chip, and a controller provided on the printer head chip to cut off power supplied to a printer in response to the sensed temperature.

The controller may include a temperature comparator to compare the sensed temperature with a predetermined critical temperature, and a power cut-off part to cut off the power supplied to the printer in response to a result of the comparison.

The apparatus may further include a surrounding-temperature sensor to sense a surrounding temperature of the printer head chip and to provide the sensed surrounding temperature to the controller such that the controller cuts off the power supplied to the printer in response to the sensed temperature and the sensed surrounding temperature.

The foregoing and/or other aspects of the present general inventive concept may also be achieved by providing a temperature control apparatus usable to control a temperature of a printer head chip of a system, the apparatus including first and second temperature sensors disposed at first and second locations of a chip to sense first and second temperatures, respectively, a heat generating component disposed on the chip, and a controller to regulate a power supply to the heat generating component according to the first and second temperatures.

The foregoing and/or other aspects of the present general inventive concept may also be achieved by providing a method of controlling a temperature of a printer head chip, the method including sensing a first temperature at a first location of the printer head chip and a second temperature at a second location of the printer head chip, and controlling a heater in the printer head chip according to the first and second sensed temperatures.

The controlling of the temperature may include determining whether the sensed first and second temperatures exceed first and second predetermined critical temperatures, respectively, and if one of the sensed first and second temperatures are determined to exceed a corresponding one of the first and second predetermined critical temperatures, controlling the heater to stop heating the printer head chip.

The sensing of the first and second temperatures may include sensing an internal temperature of the printer head chip, and sensing a surrounding temperature of the printer head chip, and the controlling may include controlling the heater according to the sensed internal temperature of the printer head chip and the sensed surrounding temperature of the printer head chip.

The sensing of the first and second temperatures may include sensing the internal temperature of the printer head chip using one of a thermistor, a diode, and a digital sensor.

The present general inventive concept may be embedded on a computer readable recording medium that records a program for performing the above-described general inventive concept on a computer.

The foregoing and/or other aspects of the present general inventive concept may also be achieved by providing a method of controlling a temperature of a printer head chip, the method including sensing at least an external temperature of the printer head chip, and cutting off power supplied to a heater in the printer head chip according to the sensed at least external temperature.

The cutting off of the power may include determining whether the sensed at least external temperature exceeds a predetermined critical temperature, and if the sensed at least external temperature is determined to exceed the critical temperature, cutting off the power supplied to the heater.

The method may further include sensing an internal temperature of the printer head chip, and sensing a surrounding temperature of the printer head chip as the external temperature, and the cutting off of the power may include cutting off the power supplied to the heater according to the sensed internal temperature of the printer head chip and the sensed surrounding temperature of the printer head chip.

The sensing of the at least the external temperature and the internal temperature may include sensing the temperature of the printer head chip using one of a thermistor, a diode, and a digital sensor.

The present general inventive concept may be embedded on a computer readable recording medium that records a program for performing the above-described general inventive concept on a computer.

The foregoing and/or other aspects of the present general inventive concept may also be achieved by providing a method of controlling a temperature of a printer head chip of a printer, the method including sensing the temperature of the printer head chip, and cutting off power supplied to the printer according to the sensed temperature.

The cutting off of the power may include determining whether the sensed temperature exceeds a predetermined critical temperature, and if the sensed temperature is determined to exceed the predetermined critical temperature, cutting off the power supplied to the printer.

The method may further include sensing a surrounding temperature of the printer head chip, and the cutting off of the power may include cutting off the power supplied to the printer according to the sensed temperature of the printer head chip and the sensed surrounding temperature of the printer head chip.

The sensing of the temperature may include sensing the temperature of the printer head chip using one of a thermistor, a diode, and a digital sensor.

The present general inventive concept may be embedded on a computer readable recording medium that records a program for performing the above-described general inventive concept on a computer.

The foregoing and/or other aspects of the present general inventive concept may also be achieved by providing a thermal inkjet printer, including a printer head chip to receive a control signal and to eject ink droplets through a plurality of nozzles according to the control signal, the head chip including a heater to heat a predetermined portion of the printer head chip, and a temperature control apparatus having a temperature sensor unit to sense an internal temperature of the printer head chip and a surrounding temperature of the printer head chip, and a controller to regulate power supplied to the heater according to the sensed temperatures.

The foregoing and/or other aspects of the present general inventive concept may also be achieved by providing a thermal inkjet printer, including a printer head chip having a base plate with a heater, and a nozzle plate formed on the base plate, a sensor to detect a temperature of the printer head chip, and a controller formed on a portion of the printer head chip to control the heater according to the detected temperature.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a conventional temperature control apparatus of a printer head chip;

FIG. 2A is a schematic partial perspective view illustrating an example of a printer head chip, according to an embodiment of the present general inventive concept;

FIG. 2B is a sectional view illustrating a vertical structure of the printer head chip of FIG. 2A;

FIG. 3 is a block diagram illustrating a temperature control an apparatus according to an embodiment of the present general inventive concept;

FIG. 4 is a block diagram illustrating a temperature control an apparatus according to another embodiment of the present general inventive concept; and

FIG. 5 is a flowchart of a method of controlling a temperature of a printer head chip according to another embodiment of the present general inventive concept.

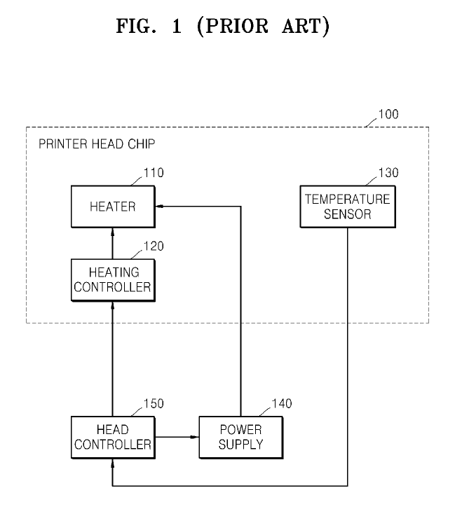

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

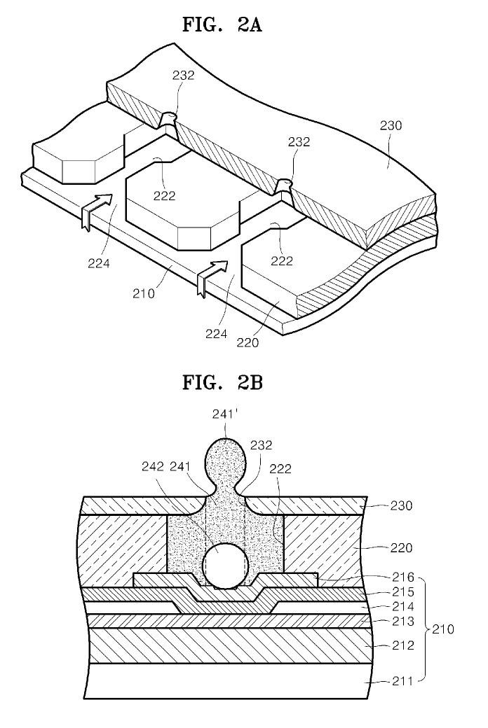

FIG. 2A is a schematic partial perspective view illustrating an example of a printer head chip. FIG. 2B is a sectional view of a vertical structure of the printer head chip illustrated in FIG. 2A. Referring to FIGS. 2A and 2B, the printer head chip includes a base plate 210 formed by stacking material layers on a substrate 211, ink chambers 222 stacked on the base plate 210, a channel plate 220 forming an ink channel 224, and a nozzle plate 230 stacked on the channel plate 220.

Ink (fluid) fills an inside of the ink chambers 222, and a heater 213 that heats the ink to create bubbles is disposed in the ink chambers 222. The ink channel 224, which is a path to supply ink to the ink chambers 222, is connected with an ink storage (not shown). The nozzle plate 230 has nozzles 232 formed at positions that correspond to the respective ink chambers 222 and through which ink is ejected from the printer head chip.

An insulation layer 212 is formed on the substrate 211 to insulate the substrate 211 from the heater 213. The insulation layer 212 may be formed by depositing a silicon oxidation layer on the substrate 211. The heater 213 is formed on the insulation layer 212 to heat the ink 241 within the ink chamber 222 to create bubbles 242. A conductor 214 is formed on, or as part of, the heater 213 to apply a current thereto.

A passivation layer 215 is formed on the heater 213 and the conductor 214 to protect the heater 213. The passivation layer 215, which prevents the heater 213 and the conductor 214 from being oxidized and from directly contacting the ink 241, may be formed by depositing a silicon nitride layer on the heater 213 and/or the conductor 214. Also, an anticavitation layer 216 made of metal, such as tantalum is formed at a portion where the ink chamber 222 is formed above the passivation layer 215.

The channel plate 220, which defines the ink chambers 222 and the ink channel 224, is stacked on the base plate 210 formed by stacking a number of material layers on the substrate 211. The nozzle plate 230 having the nozzles 232 formed therein is stacked on the channel plate 220.

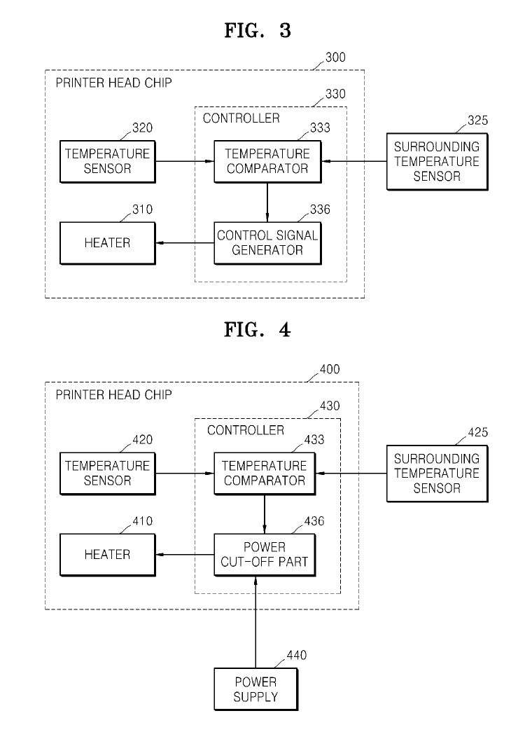

FIG. 3 is a block diagram illustrating a temperature control apparatus of a printer head chip 300 according to an embodiment of the present general inventive concept. The temperature control apparatus of FIG. 3 may be used with the printer head chip of FIGS. 2A and 2B. Accordingly, for illustration purposes, the temperature control apparatus of FIG. 3 is described below with reference to FIGS. 2A through 3. The temperature control apparatus includes the printer head chip 300 and a surrounding temperature sensor 325. The printer head chip 300 includes a heater 310 (similar to the heater 213 of FIG. 2B), a temperature sensor 320, and a controller 330. The controller 330 includes a temperature comparator 333 and a control signal generator 336. According to the present embodiment, the temperature sensor 320 and the controller 330 may be disposed on a portion of the printer head chip of FIGS. 2A and 2B, for example, mounted on a portion of the base plate 210 or the insulation layer 212 or the substrate 211 of the base plate 210, and the control signal generator 336 is connected through the conductor 214 to the heater 213 of the printer head chip of FIGS. 2A and 2B.

The printer head chip 300 heats the ink 241 contained in the ink chambers 222 using heat generated by the heater 310 that corresponds to the heater 213 of FIG. 2B to create the bubbles 242. As the bubbles 242 expand, pressure is applied to the ink 241 contained in the ink chambers 222, so that ink droplets 241′ are ejected out of the printer head chip 300 through the nozzles 232.

The printer head chip 300 includes the heater 310 (213), the temperature sensor 320, and the controller 330.

The heater 310 (213) heats a predetermined portion of the printer head chip 300. The portion heated by the heater 310 (213) refers to a portion that transfers the heat to the ink contained in the ink chambers 222 to eject ink droplets 241′ out of the printer head chip 300.

The temperature sensor 320 senses the temperature (e.g., an internal temperature) of the printer head chip 300 and provides the sensed temperature to the temperature comparator 333. The temperature sensor 320 may be one of a thermistor, a diode sensor, and/or a digital sensor that uses a resistor having a resistance that varies according to the temperature. Other devices that achieve the purposes set forth herein may alternatively be used as the temperature sensor 320.

The surrounding-temperature sensor 325 is provided outside of the printer head chip 300 at a predetermined distance therefrom to sense a surrounding temperature of the printer head chip 300 and to provide the sensed surrounding temperature to the temperature comparator 333.

The controller 330 provides a control signal to the heater 310 (213) in response to the temperature sensed by the temperature sensor 320.

The controller 330 includes the temperature comparator 333 and the control signal generator 336.

The temperature comparator 333 compares the temperature sensed by the temperature sensor 320 (e.g., the internal temperature of the printer head chip 300) with a first preset critical temperature and provides a result of the comparison to the control signal generator 336.

Also, the temperature comparator 333 compares the temperature sensed by the surrounding-temperature sensor 325 (e.g., an external temperature of the printer head chip 300) with a second preset critical temperature and provides a result of the comparison to the control signal generator 336.

The control signal generator 336 outputs a control signal that stops the heater 310 (213) from heating, in response to the results of the comparisons performed by the temperature comparator 333 and/or the surrounding-temperature sensor 325. If the temperature sensed by the temperature sensor 320 exceeds the first critical temperature or the surrounding temperature sensed by the surrounding-temperature sensor 325 exceeds the second critical temperature, the control signal generator 336 shuts down and disables the heater 310 (213) so that a circuit of the heater 310 may not operate.

FIG. 4 is a block diagram illustrating a temperature control apparatus according to another embodiment of the present general inventive concept. The temperature control apparatus of FIG. 4 may be used with the printer head chip of FIGS. 2A and 2B. Accordingly, for illustration purposes, the temperature control apparatus of FIG. 4 is described below with reference to FIGS. 2A, 2B, and 4. The temperature control apparatus includes a printer head chip 400, a surrounding-temperature sensor 425, and a power supply 440. The printer head chip 400 includes a heater 410 (similar to the heater 213 of FIG. 2B), a temperature sensor 420, and a controller 430. The controller 430 includes a temperature comparator 433 and a power cut-off part 436.

The printer head chip 400 heats the ink 241 contained in the ink chambers 222 using heat generated by the heater 410 (213) to create the bubbles 242. As the bubbles 242 continue to expand, pressure is applied to the ink 241 contained in the ink chambers 222, so that the ink droplets 241′ are ejected out of the printer head chip 400 through the nozzles 232.

The printer head chip 400 includes the heater 410 (213), the temperature sensor 420, and the controller 430.

The heater 410 (213) heats a predetermined portion of the printer head chip 400. The portion heated by the heater 410 refers to a portion that transfers the heat to the ink 241 contained in the ink chambers 222 to eject the ink droplets 241′ out of the printer head chip 400.

The temperature sensor 420 senses a temperature of the printer head chip 400 (e.g., an internal temperature of the printer head chip 400) and provides the sensed temperature to the temperature comparator 433. The temperature sensor 420 may be one of a thermistor, a diode sensor, and/or a digital sensor that uses a resistor having a resistance that varies according to temperature. Other devices that achieve the purposes set forth herein may alternatively be used as the temperature sensor 420.

The surrounding-temperature sensor 425 is provided to the outside of the printer head chip 400 a predetermined distance therefrom to sense a surrounding temperature of the printer head chip 400 (e.g., an external temperature of the printer head chip 400) and provides the sensed surrounding temperature to the temperature comparator 433.

The controller 430 cuts off power supplied to the heater 410 (213) according to the temperature sensed by the temperature sensor 420.

The controller 430 includes the temperature comparator 433 and a power cut-off part 436.

The temperature comparator 433 compares the temperature sensed by the temperature sensor 420 with a first preset critical temperature and provides a result of the comparison to the power cut-off part 436.

Also, the temperature comparator 433 compares the temperature sensed by the surrounding-temperature sensor 425 with a second preset critical temperature and outputs a result of the comparison to the power cut-off part 436.

The power supply 440 supplies power to the heater 410 (213).

The power cut-off part 436 cuts off power supplied from the power supply 440 to the heater 410 (213) according to results of the comparisons performed by the temperature comparator 433. The power cut-off part 436 cuts off power supplied from the power supply 440 to the heater 410 (213) if (1) the temperature sensed by the temperature sensor 420 exceeds the first critical temperature or (2) the temperature sensed by the surrounding-temperature sensor 425 exceeds the second critical temperature.

Also, the power cut-off part 436 may cut off power supplied to an entire system (printer) according to the results of the comparisons performed by the temperature comparator 433. That is, the power cut-off part 436 cuts off power supplied to the entire system if (1) the temperature sensed by the temperature sensor 420 exceeds the first critical temperature or (2) the temperature sensed by the surrounding-temperature sensor 425 exceeds the second critical temperature.

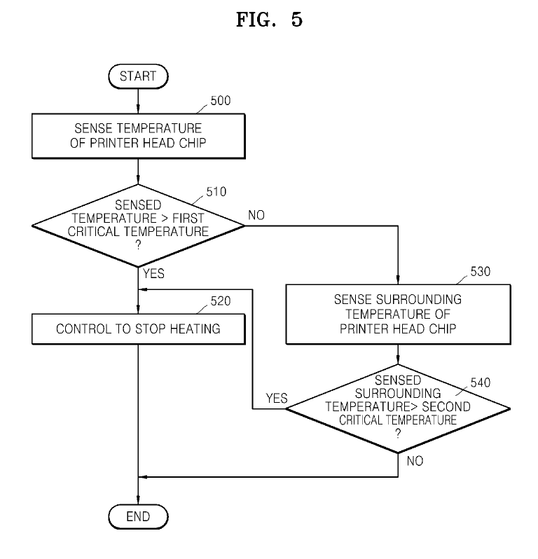

FIG. 5 is a flowchart illustrating a method of controlling a temperature of a printer head chip according to an embodiment of the present general inventive concept. The method of FIG. 5 may be performed by either one of the temperature control apparatuses of FIG. 3 or 4.

The method relates to a thermal inkjet printer having a heater that heats a predetermined portion of a printer head chip and a controller to control the printer head chip and to regulate the temperature of the printer head chip.

First, the temperature within the printer head chip is sensed (operation 500). In the operation 500, one of a thermistor, a diode sensor, and a digital sensor may be provided to the printer head chip to sense the temperature thereof.

Additionally, it is determined whether the temperature of the printer head chip sensed in the operation 500 exceeds a first critical temperature (operation 510).

If the temperature of the printer head chip is determined to exceed the first critical temperature, the controller controls the heater to stop heating the printer head chip (operation 520). In the operation 520, the controller may shutdown and disable the heater so that a circuit of the heater may not operate.

If the temperature of the printer head chip is determined not to exceed the first critical temperature, a surrounding temperature of the printer head chip is sensed (operation 530).

It is then determined whether the surrounding temperature of the printer head chip sensed in the operation 530 exceeds a second critical temperature (operation 540).

If the surrounding temperature of the printer head chip is determined to exceed the second critical temperature in the operation 540, the controller controls the heater to stop heating the printer head chip (operation 520). In the operation 520, the controller may shutdown and disable the heater so that a circuit of the heater may not operate.

Alternatively, in the method of controlling the temperature of the printer head chip, the operation 520 may be replaced by an operation of cutting off power supplied to the heater.

Alternatively, in the method, the operation 520 may be replaced by an operation of cutting off power supplied to an entire system (printer).

The controller 330 or 430 may be provided in the printer head chip 300 or 400, respectively, such that communication between the temperature sensor 320 or 420 (i.e., internal temperature sensor) is efficiently performed. Accordingly, the controller 330 or 430 may efficiently regulate the temperature of the printer head chip 300 or 400, respectively. For example, when an internal temperature of the printer head chip 300 or 400 rises above the first critical temperature, the controller 330 or 430 can control the heater 310 or 410, respectively, to stop heating, thereby preventing any type of safety hazard or equipment failure.

Additionally, the controller 330 or 430 may be integrated with the temperature sensor 320 or 420, respectively, or may be formed separately therefrom. The internal temperature sensor 320 or 420 may, for example, be positioned in the ink chamber(s) 222, the ink channel(s) 224, etc. The surrounding temperature sensor 325 or 425 (i.e., an external temperature sensor) may be positioned outside the printer head chip 300 or 400, respectively, for example, outside a nozzle array, on a side of the printer head chip 300 or 400, on a side of an ink cartridge, on a circuit board, etc.

The general inventive concept can also be embodied as computer readable codes on a computer readable recording medium. The computer readable recording medium may be any data storage device that can store data, which can be thereafter read by a computer system. Examples of the computer readable recording medium include read-only memory (ROM), random-access memory (RAM), CD-ROMs, magnetic tapes, floppy disks, and optical data storage devices. The controllers 330 and 430 and/or other components may be implemented in the computer readable codes.

According to the above-described embodiments of a method and a temperature control apparatus of a printer head chip, overheating of the printer head chip can be prevented by a controller associated with the printer head chip. Accordingly, the temperature of the printer head chip can be controlled even when the temperature inside of the printer head chip abruptly rises or an error occurs in a main system of the printer.

Also, according to the various embodiments of the present general inventive concept, damage to a printer head chip is prevented and safety is guaranteed when using the printer. Additionally, ink droplets can be accurately ejected such that printing quality improves and a life span of the heater can be extended.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to control a temperature of a printer head chip in a thermal inkjet printer, the apparatus comprising:
a heater to heat a predetermined portion of the printer head chip;
a temperature sensor provided on the printer head chip to sense a temperature of the printer head chip; and
a controller provided on the printer head chip to control the heater according to the sensed temperature.

2. The apparatus of claim 1, wherein the controller comprises:
a temperature comparator to compare the sensed temperature with a predetermined critical temperature and to output a result of the comparison; and
a control signal generator to provide a control signal that stops the heater from heating the printer head chip in response to the result of the comparison.

3. The apparatus of claim 1, further comprising:
a surrounding-temperature sensor disposed outside the printer head chip to sense a surrounding temperature of the printer head chip and to provide the sensed surrounding temperature to the controller such that the controller outputs a control signal to the heater in response to the sensed temperature and the sensed surrounding-temperature.

4. The apparatus of claim 1, wherein the temperature sensor is one of a thermistor, a diode sensor, and a digital sensor.

5. The apparatus of claim 1, wherein the controller and the sensor are disposed inside the printer head chip.

6. The apparatus of claim 1, wherein the controller cuts off power supplied to the heater according to the sensed temperature.

7. A temperature control apparatus of a printer head chip in a thermal inkjet printer, the apparatus comprising:
a heater to heat a predetermined portion in the printer head chip;
a temperature sensor unit to sense an internal temperature of the printer head chip and a surrounding temperature of the printer head chip; and
a controller provided on the printer head chip to cut off power supplied to the heater according to the sensed internal and surrounding temperatures.

8. The apparatus of claim 7, wherein the controller comprises:
a temperature comparator to compare the sensed internal and surrounding temperatures with predetermined critical temperatures and to output a result of the comparison; and
a power cut-off part to cut off power supplied to the heater in response to the result of the comparison.

9. The apparatus of claim 7, wherein the temperature sensor unit comprises:
an internal temperature sensor disposed in the printer head chip to sense the internal temperature of the printer head chip; and
a surrounding-temperature sensor disposed outside the printer head chip to sense the surrounding temperature of the printer head chip and to provide the sensed surrounding temperature to the controller such that the controller cuts off power supplied to the heater in response to the sensed internal temperature and the sensed surrounding temperature.

10. The apparatus of claim 7, wherein the temperature sensor unit comprises one of a thermistor, a diode sensor, and a digital sensor.

11. An apparatus to control a temperature of a printer head chip provided in a thermal inkjet printer, the apparatus comprising:
a temperature sensor provided on the printer head chip to sense a temperature of the printer head chip; and
a controller provided on the printer head chip to cut off power supplied to the printer according to the sensed temperature.

12. The apparatus of claim 11, wherein the controller comprises:
a temperature comparator to compare the sensed temperature with a predetermined critical temperature and to output a result of the comparison; and
a power cut-off part to cut off power supplied to the printer in response to the result of the comparison.

13. The apparatus of claim 11, further comprising:
a surrounding-temperature sensor to sense a surrounding temperature of the printer head chip and to provide the sensed surrounding temperature to the controller such that the controller cuts off power supplied to the printer according to the sensed temperature and the sensed surrounding temperature.

14. The apparatus of claim 11, wherein the temperature sensor is one of a thermistor, a diode sensor, and a digital sensor.

15. The apparatus of claim 11, wherein the controller and the temperature sensor are disposed inside the printer head chip.

16. The apparatus of claim 11, wherein the controller regulates power supplied to the heater according to the sensed temperature.

17. A method of controlling a temperature of a printer head chip in a thermal inkjet printer having a heater that heats a predetermined portion of the printer head chip, the method comprising:
sensing a first temperature at a first location of the printer head chip and a second temperature at a second location of the printer head chip; and
controlling a heater in the printer head chip according to the first and second sensed temperatures.

18. The method of claim 17, wherein the controlling of the heater comprises:
determining whether the first and second sensed temperatures exceed first and second predetermined critical temperatures, respectively; and
if one of the first and second sensed temperatures are determined to exceed a corresponding one of the first and second predetermined critical temperatures, controlling the heater to stop heating the predetermined portion.

19. The method of claim 17, wherein the sensing of the first and second temperatures comprises:
sensing an internal temperature of the printer head chip; and
sensing a surrounding temperature of the printer head chip, and the controlling of the heater comprises controlling the heater according to the sensed internal temperature of the printer head chip and the sensed surrounding temperature of the printer head chip.

20. The method of claim 17, wherein the sensing of the first and second temperatures comprises sensing an internal temperature of the printer head chip using one of a thermistor, a diode, and a digital sensor.

21. A computer readable recording medium containing executable code to perform a method of controlling a temperature of a printer head chip in a thermal inkjet printer having a heater that heats a predetermined portion of the printer head chip, the method comprising:
sensing a first temperature at a first location of the printer head chip and a second temperature at a second location of the printer head chip; and
controlling a heater according to the first and second sensed temperatures.

22. A method of controlling a temperature of a printer head chip in a thermal inkjet printer having a heater that heats a predetermined portion of the printer head chip, the method comprising:
sensing at least an external temperature of the printer head chip; and
cutting off power supplied to the heater according to the sensed at least external temperature.

23. The method of claim 22, wherein the cutting off of the power comprises:
determining whether the sensed at least external temperature exceeds a predetermined critical temperature; and
if the sensed at least external temperature is determined to exceed the critical temperature, cutting off the power supplied to the heater.

24. The method of claim 22, further comprising:
sensing an internal temperature of the printer head chip; and
sensing a surrounding temperature of the printer head chip as the external temperature such that the cutting off of the power comprises cutting off the power supplied to the heater according to the sensed internal temperature of the printer head chip and the sensed surrounding temperature of the printer head chip.

25. The method of claim 22, wherein the sensing of the at least external temperature comprises sensing the temperature of the printer head chip using one of a thermistor, a diode, and a digital sensor.

26. A computer readable recording medium containing executable code to perform a method of controlling a temperature of a printer head chip in a thermal inkjet printer having a heater that heats a predetermined portion of the printer head chip, the method comprising:
sensing at least an external temperature of the printer head chip; and
cutting off power supplied to the heater according to the sensed at least external temperature.

27. A method of controlling a temperature of a printer head chip in a thermal inkjet printer, the method comprising:
sensing the temperature of the printer head chip; and
cutting off power supplied to the printer according to the sensed temperature.

28. The method of claim 27, wherein the cutting off comprises:
determining whether the sensed temperature exceeds a predetermined critical temperature; and
if the sensed temperature is determined to exceed the predetermined critical temperature, cutting off the power supplied to the printer.

29. The method of claim 27, further comprising:
sensing a surrounding temperature of the printer head chip such that the cutting off of the power comprises cutting off the power supplied to the printer according to the sensed temperature of the printer head chip and the sensed surrounding temperature of the printer head chip.

30. The method of claim 27, wherein the sensing of the temperature comprises sensing the temperature of the printer head chip using one of a thermistor, a diode, and a digital sensor.

31. A computer readable recording medium containing executable code to perform a method of controlling a temperature of a printer head chip in a thermal inkjet printer, the method comprising:
sensing the temperature of the printer head chip; and
cutting off power supplied to the printer according to the sensed temperature.

32. A thermal inkjet printer, comprising:
a printer head chip to receive a control signal and to eject ink droplets through a plurality of nozzles according to the control signal, the head chip including:
a heater to heat a predetermined portion of the printer head chip; and
a temperature control apparatus having a temperature sensor unit to sense an internal temperature of the printer head chip and a surrounding temperature of the printer head chip, and a controller to regulate power supplied to the heater according to the sensed internal and surrounding temperatures.

33. A thermal inkjet printer, comprising:
a printer head chip comprising a base plate having a heater, and a nozzle plate formed on the base plate;
a sensor to detect a temperature of the printer head chip; and
a controller formed on a portion of the printer head chip to control the heater according to the detected temperature.

34. The thermal inkjet printer of claim 33, wherein the sensor comprises a first sensor formed on a second portion of the printer head chip, and a second sensor formed on an outside portion of the printer head chip to detect first and second temperatures as the temperature of the printer head chip.

35. The thermal inkjet printer of claim 33, wherein the controller is formed on one of the base plate and the nozzle plate of the printer head chip.
